(19) United States
(12) Patent Application Publication
(10) Pub. No.: US 2014/0083925 A1
(43) Pub. Date: Mar. 27, 2014

(54) Multi-layer Separation Membrane Formed by Molecular Layer-by-Layer Deposition of Highly Cross-linked Polyamide Films

(71) Applicants: Christopher M. Stafford, Ijamsville, MD (US); Peter M. Johnson, Evansville, IN (US)

(72) Inventors: Christopher M. Stafford, Ijamsville, MD (US); Peter M. Johnson, Evansville, IN (US)

(73) Assignee: The United States of America as represented by the Secretary of Commerce, Gaithersburgh, MD (US)

(21) Appl. No.: 13/897,204

(22) Filed: May 17, 2013

Related U.S. Application Data
(60) Provisional application No. 61/648,114, filed on May 17, 2012.

(51) Int. Cl. B01D 71/28; B01D 69/12

(52) U.S. Cl. CPC B01D 71/28; B01D 69/125
USPC 210/489; 427/9

(57) ABSTRACT

This invention relates to the field of molecular layer-by-layer deposition processes and more specifically to the synthesis of a polymer layer relevant to a separation membrane using molecular layer-by-layer deposition of highly cross-linked polyamide films to promote consistent layer growth consistent for the formation of membrane layers having a uniform chemical composition and thickness.

### CROSS-REFERENCE TO RELATED APPLICATION

This application claims priority to U.S. Provisional Application No. 61/648,114 filed on May 17, 2012.

### STATEMENT OF GOVERNMENT INTEREST

The invention described herein was made by employees of the United States Government and may be manufactured and used by or for the Government of the United States of America for governmental purposes without the payment of royalties.

### FIELD OF INVENTION

This invention relates to the field of molecular layer-by-layer deposition processes and more specifically to the synthesis of a multi-layer separation membrane using molecular layer-by-layer deposition of highly cross-linked polyamide films.

### BRIEF DESCRIPTION OF THE DRAWINGS

FIG. 1 is a flow chart of an exemplary method for the creation of a multi-layer separation membrane formed by cyclical molecular layer-by-layer (mLbL) deposition of highly cross-linked polyamide films.

FIG. 2 is a schematic showing the stages of the synthesis of separation membrane formed by cyclical molecular layer-by-layer deposition of highly cross-linked polyamide films.

FIG. 3a is a plot of film thickness as a function of cycle deposition using cyclical molecular layer-by-layer deposition of highly cross-linked polyamide films.

FIG. 3b is a Fourier Transform Infrared (FTIR) plot illustrating the wavelength patterns that represent the presence of cross-linked polyamide bonds formed during an exemplary molecular layer-by-layer deposition process.

FIGS. 4a and 4b are Atomic Force Microscopic (AFM) images which illustrate the uniform thickness of the surface of the top layer of a separation membrane synthesized by an exemplary cyclical mLbL method.

FIG. 5 is a graph depicting a height image of the surface of the top layer of a separation membrane synthesized by the exemplary cyclical mLbL method disclosed herein as compared to the surface of a commercially available polyamide membrane.

### ACRONYMS

AFM—Atomic Force Microscopy

FTIR—Fourier Transform Infrared Spectroscopy

mLbL—molecular Layer-by-Layer

MPD—m-Phenylene Diamine

PEM—Polyelectrolyte Multilayers

PVA—Poly(Vinyl Alcohol)

TMC—Trimesoyl Chloride

XPS—X-ray Photoelectron Spectroscopy

### TERMS OF ART

As used herein, the term “cyclical mLbL” means a molecular layer-by-layer process performed for a predetermined number of cycles, wherein each cycle results in a uniform or substantially uniform deposition relative to the previous cycle, i.e., the layer formed during a current cycle is not altered by the deposition of a previous cycle because of the use of rinsing solvents and/or a drying process between deposition cycles.

As used herein, the term “uniform” refers to a layer which is chemically uniform which has conformed and/or predetermined thickness. A uniform layer has reduced surface variations when viewed microscopically.

As used herein, the term “target permeability value” means target performance in terms of water flux and solute rejection.

### BACKGROUND

Functional polymers are polymers with specialized optic and/or electronic properties. The properties of functional polymers can be manipulated and various polymers having desired properties can be synthesized to form various types of membranes which act as filters, such as reverse osmosis membranes which are known in the art. Membrane processes that involve the use of dense selective layers, such as reverse osmosis and nanofiltration are used for treatment of sea water, brackish water, industrial waste water, and greywater.

Layer-by-Layer deposition is a process known in the art which is used to form polymer membranes by depositing nanometer scale coatings to form nano-structures and membranes for film or polyelectrolyte multilayers (PEM), where charge interaction binds oppositely charged polymers or nanomaterials.

One form of layer-by-layer assembly known in the art is molecular layer-by-layer (mLbL) synthesis, where molecular layers are deposited through the reaction of alternating pendant functional groups. MLbL sythesis has been used successfully for polyurea, polyimide, linear polyamide, and other specialized polymers. Synthesis and bonding are accomplished by polycondensation reactions, which create alternating layers as a result of stoichiometry limitations.

MLbL layers of polyamide membranes are formed by producing an acid chloride and amine condensation reaction that occurs rapidly to form either linear chains or a dense polymer network, depending on the functionality of the monomers.

Reverse osmosis membranes, known in the art, are comprised of highly cross-linked networks that may be used as the salt discriminating layers, allowing the passage of water through the network while rejecting larger salt ions. To form the polyamide film used in reverse osmosis membranes, interfacial polymerization of TMC and MPD occurs at an organic-water interface.

Although effective, the rapid polymerization rate and reaction conditions produce films with rough surface structures and chemical heterogeneity. A problem known in the art is controlling the reaction rate (“end capping”) of polymer functional groups to prevent the formation of layers have widely varying chemical compositions and irregularities in their surface structures.

The non-uniform thicknesses and chemical compositions nature of these limits their scientific usefulness. Without the ability to produce conformed membranes it is difficult to accurately characterize and standardize membrane properties. Irregularities in the composition and thickness of membrane layers are a problem known in the art which hinder the utility and quantification of the characteristics of the membranes for performing in-depth profiling and measurement analysis required for many scientific and commercial applications.

There is an unmet need in the art for membranes that have layers which are chemically homogeneous as possible and which can be produced with uniform thicknesses.

The present invention produces a conformed membrance structure comprised of chemically homogeneous layers having a uniform thickness consistent film growth rates within each mLbL deposition cycle. These uniform growth rates critical to the formation of smooth conformal membrane layers, and in particular to minimizing end-capping reactions with acid chloride which cause inconsistent growth rates.

### SUMMARY OF THE INVENTION

The present invention produce standardized, conformed membrane structures comprised of chemically homogeneous layers which have a substantially uniform thickness. The process by which the membrane layers are formed inherently produces consistent film growth rates within each mLbL deposition cycle. These uniform growth rates are critical to the formation of smooth conformal membrane layers, and in particular to minimizing “end-capping” reactions with acid chloride which cause inconsistent growth rates.

### DETAILED DESCRIPTION OF THE INVENTION

For the purpose of promoting an understanding of the present invention, references are made to a multi-layer separation membrane formed by molecular layer-by-layer deposition of highly cross-linked polyamide films described herein. It should be understood that no limitations on the scope of the invention are intended by describing these exemplary embodiments. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention. It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

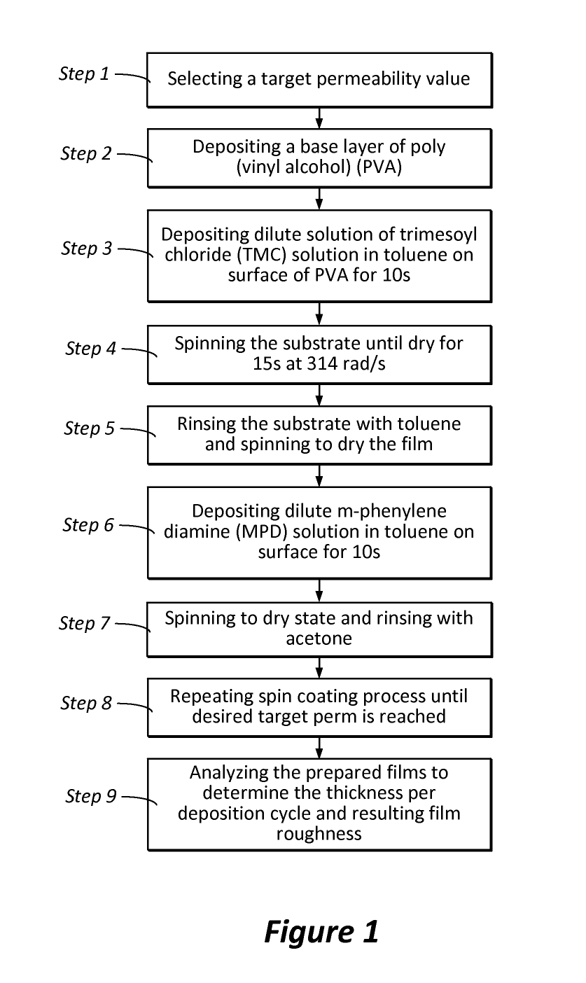

FIG. 1 illustrates an exemplary uniform growth mLbL (UG mLbL) method 100 for a solvent-based mLbL deposition (mLbL) technique to synthesize crosslinked polyamide films with reduced surface roughness. UG mLbL method 100 builds a crosslinked polyamide network via successive exposures to TMC and MPD. In exemplary UG mLbL method 100 four solutions are sequentially deposited on a PVA-coated substrate during each deposition cycle.

Exemplary UG mLbL method 100 utilizes approximately thirty depositions. In various embodiments, more or fewer deposition cycles may be utilized.

Exemplary UG mLbL method 100 prevents uncontrolled polymerization by limiting reaction sites to surface bound moieties. Films can be grown on any substrate that presents a high density of chemical groups reactive to the carboxylic acid chloride functionality of TMC. Grown films have over an order of magnitude decrease in the surface roughness as compared to commercial interfacially polymerized films while maintaining a high crosslink density.

FIG. 1 is a flow chart of an exemplary method for the creation of a multi-layer separation membrane formed by cyclical molecular layer-by-layer deposition of highly cross-linked polyamide films.

In Step 01 of exemplary UG mLbL method 100, “target permeability values” are determined. The target permebility flow rate values are in the range of 3-60 m³/day. The target values for salt rejection range is 0-99.9% and the target boron rejection range is 0-99.9%.

In Step 02 of exemplary UG mLbL method 100, the step of forming a PVA substrate by spin coat depositing a base layer of PVA of reactant solution on a substrate is performed. Exemplary UG mLbL method 100 uses a process similar to spin-assisted layer-by-layer assembly of oppositely charged polymer electrolytes.

In this exemplary embodiment, a spin-coater is used to spread the reactant solution evenly on the substrate. Because of the high reactivity of carboxylic acid chlorides to alcohols and amines, a primer layer of alcohol is deposited. In the exemplary embodiment, polyvinyl alcohol (PVA) is used as a primer layer, although other primer substances layers could be employed. The surface must be reactive with acyl chloried which includes alcohol, primary/secondary amines and carboxolic acids. These chemicals may either be present in the primary layer or a surface may be functionally adapted or equivalent to these chemical groups.

In Step 03 of exemplary UG mLbL method 100, the step of depositing dilute solution of TMC solution in toluene on the surface of the PVA-coated substrate for 10s is performed. The TMC solution reacts with the alcohol groups on the PVA-coated substrate.

In Step 04 of exemplary UG mLbL method 100, the step of spinning the substrate to dry and remove any unreacted monomers for 15s at 314 rad/s is performed. In the exemplary embodiment, the reaction occurs on the order of one second, extra time was provided to ensure maximum conversion at the surface.

In Step 05 of exemplary UG mLbL method 100, the critical step of rinsing the substrate with toluene and spinning to dry the film is performed. In the exemplary embodiment, after the first cycle the substrate surface is comprised of unreacted carboxylic acid chlorides.

In Step 06 of exemplary UG mLbL method 100, the step of depositing dilute m-phenylene diamine (MPD) solution in toluene on the acid chloride functionalized surface for 1 Os is performed.

In Step 07 of exemplary UG mLbL method 100, the critical step of spinning the membrane that is being synthesized to a dry state and rinsing the membrane with acetone to remove any excess MPD is performed. Acetone is required since MPD is only sparingly soluble in most nonpolar solvents. It is critical that deposits of MPD be cleansed from the exposed reactive layer which may or may not form a new substrate after each deposition cycle.

In Step 08 of exemplary UG mLbL method 100, the step of repeating the spin coating process until predetermined target perm value is reached is performed.

In Step 09 of exemplary UG mLbL method 100, the step of analyzing the prepared films to determine the thickness per deposition cycle and resulting film roughness is performed. In the exemplary embodiment, network structure is quantified through Fourier Transform Infrared (FTIR) Spectroscopy and X-ray Photoelectron Spectroscopy (XPS).

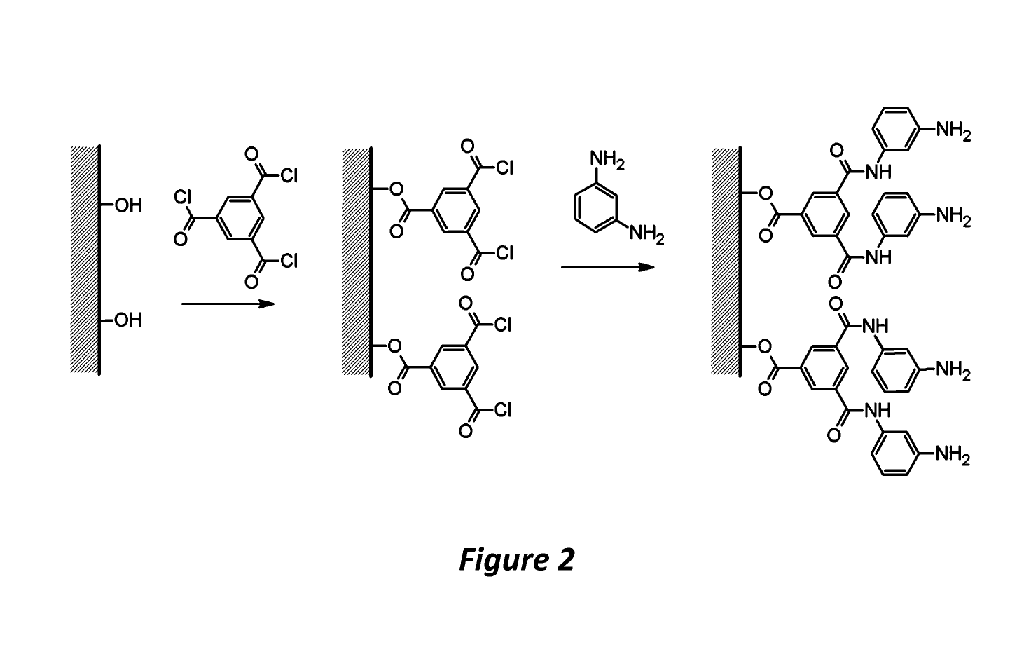

FIG. 2 is a schematic showing the stages of the synthesis of separation membrane formed by cyclical molecular (mLbL) layer-by-layer deposition of highly cross-linked polyamide films.

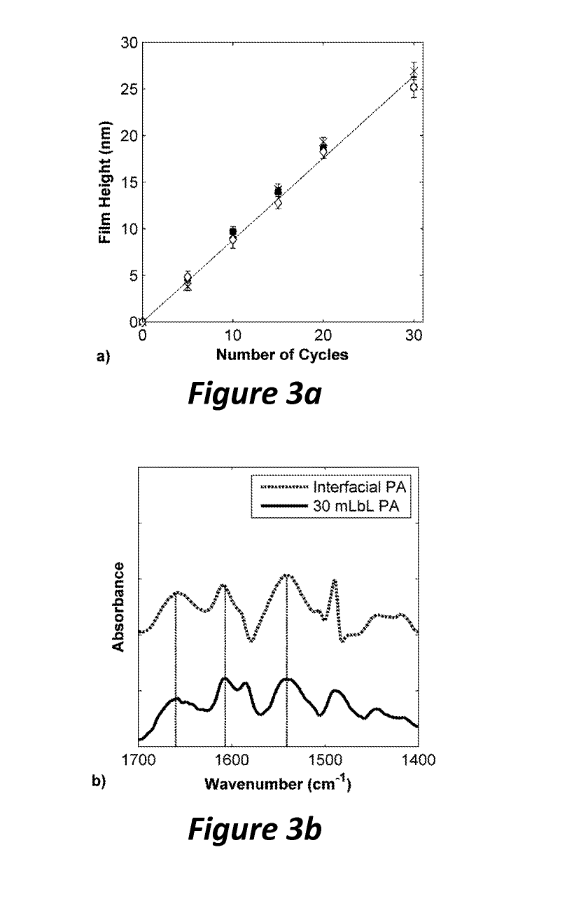

FIG. 3a is a plot of film thickness as a function of cycle deposition using cyclical molecular layer-by-layer deposition of highly cross-linked polyamide films.

FIG. 3b is a Fourier Transform Infrared (FTIR) plot illustrating the wavelength patterns that represent the presence of cross-linked polyamide bonds formed during an exemplary molecular layer-by-layer deposition process.

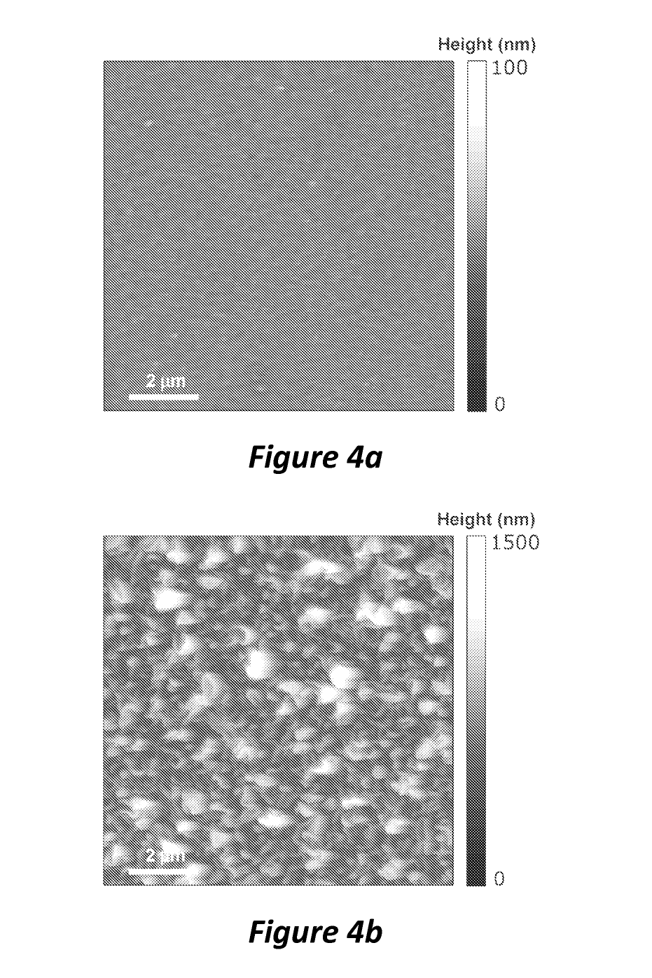

FIGS. 4a and 4b are Atomic Force Miscroscopic (AFM) images which illustrate differences in the uniformity of the surface of the top layer of a separation membrane synthesized by an exemplary cyclical mLbL method.

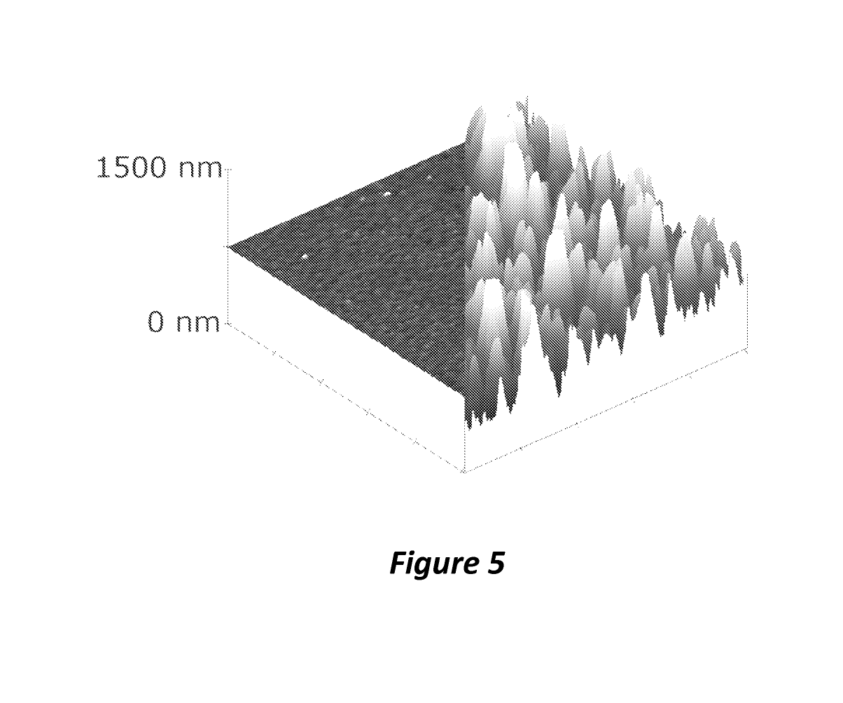

FIG. 5 is graph depicting a height image of the surface of the top layer of a reverse membrane synthesized by the exemplary cyclical mLbL method disclosed herein as compared to the surface of a commercially available polyamide.

For comparison, interfacially polymerized polyamide from a commercial reverse osmosis membrane may be used as a reference for a polyamide structure. Since stoichiometry limits the polymerization to a single molecular layer at a time, the maximum film thickness growth per cycle is controlled by chemical structure and conversion. The maximum growth per cycle for a TMC/MPD repeat unit would be 1.2 nm per cycle, which would require all chain growth to be directed orthogonal to the substrate surface. Using optical profilometry, the film thickness, h, is measured as a function of the number of cycles.

What is claimed is:

1. A multi-layer separation membrane comprised of:
at least one chemically compatible support substrate;
at least one reacted multifunctional acid chloride layer;
a plurality of diamine layers having a target thickness and target chemical composition;
a plurality of reacted multifunctional acid chloride layers having a substantially uniform thickness and chemical composition; and
wherein said plurality of diamine layers and said plurality of reacted multifunctional acid chloride layers are alternated to form said multi-layered membrane.

2. The apparatus of claim 1 wherein each of said plurality of acid chloride layers is comprised of acid chlorides with a functionality greater than or equal to 2 selected from a group consisting of isophthaloyl halide, trimesoyl halide, terephthaloyl halide and combinations thereof.

3. The apparatus of claim 1 wherein each of said plurality acid chloride layers are distinct from each other wherein said plurality of acid chloride layer groups is comprised of acid chlorides with a functionality greater than or equal to 2 selected from a group consisting of isophthaloyl halide, trimesoyl halide, terephthaloyl halide and combinations thereof.

4. The apparatus of claim 1 wherein the average functionality (f_{avg}) of said apparatus, calculated as (fₐₘᵢₙₑ+f_{acid chloride})/2, has a value greater than 2 and comprises a cross-linked membrane.

5. The apparatus of claim 1 wherein each of said plurality of amine layers are selected from a group consisting of aromatic primary diamines with a functionality greater than or equal to 2, such as m-phenylenediamine and p-phenylenediamine and substituted derivatives thereof, wherein the substituent includes, e.g., an alkyl group, such as a methyl group or an ethyl group; an alkoxy group, such as a methoxy group or an ethoxy group; a hydroxy alkyl group; a hydroxy group or a halogen atom; cycloaliphatic primary diamines, such as cyclohexane diamine; cycloaliphatic secondary diamines, such as piperizine and trimethylene dipiperidine; aromatic secondary diamines, such as N,N′-diphenylethylene diamine; and xylylene diamine; and combinations thereof.

6. The apparatus of claim 1 wherein each of said plurality of amine layers are distinct from each other wherein said plurality of amine layers group are comprised of aromatic primary diamines with a functionality greater than or equal to 2, such as m-phenylenediamine and p-phenylenediamine and substituted derivatives thereof, wherein the substituent includes, e.g., an alkyl group, such as a methyl group or an ethyl group; an alkoxy group, such as a methoxy group or an ethoxy group; a hydroxy alkyl group; a hydroxy group or a halogen atom; cycloaliphatic primary diamines, such as cyclohexane diamine; cycloaliphatic secondary diamines, such as piperizine and trimethylene dipiperidine; aromatic secondary diamines, such as N,N′-diphenylethylene diamine; and xylylene diamine.

7. The apparatus of claim 1 wherein each of said plurality of acid chloride layers have a substantially uniform thickness relative to each other of said plurality of acid chloride layers.

8. The apparatus of claim 1 wherein each said amine layers have a uniform chemical composition relative to each other of said plurality of acid chloride layers.

9. The apparatus of claim 1 wherein each of said plurality of amine layers have a substantially uniform thickness relative to each of other of said plurality of acid chloride layers.

10. The apparatus of claim 1 wherein each said acid chloride layers have a uniform chemical composition relative to each other of said plurality of each said acid chloride layers

11. The apparatus of claim 1 wherein each of said plurality of said acid chloride layers is 0.25 to 0.5 nanometers thick.

12. The apparatus of claim 1 wherein each of said plurality of said acid chloride layers is 0.25 to 0.5 nanometers thick.

13. The apparatus of claim 1 wherein the thickness of said acid chloride layer and amine layer are proportional to the molecular size of the acid chloride and amine molecules.

14. The apparatus of claim 1 wherein the thickness of each of said plurality of acid layers and each of said plurality of amine layers is determined by a molecular size coefficient.

15. The apparatus of claim 1 wherein the total thickness of said separation membrane is variably based upon a target number of layers based upon a predetermined permeability selectivity value.

16. The apparatus of claim 1 wherein said plurality of acid chloride layers have a substantially uniform concentration of molecules and molecular size.

17. The apparatus of claim 1 wherein said plurality of amine layers have a substantially uniform concentration of molecules and molecular size.

18. A method of forming a multi-layered separation membrane which comprises the following steps:
forming a porous PVA substrate by spin coat depositing a base layer of PVA of reactant solution on a substrate;
depositing dilute solution of TMC solution in toluene on the surface of the PVA-coated substrate for 10s to form a homogeneous dense chloride on said substrate single layer with a uniform concentration of molecules;
spinning the substrate until dry to remove any unreacted monomers for 15s at 314 rad/s;
rinsing the substrate with toluene and spinning to dry the film;
depositing dilute MPD solution in toluene on the acid chloride functionalized surface for 10s to form a homogeneous dense diamine single layer with a uniform concentration of molecules;
spinning to a dry state and rinsing with acetone to remove any excess MPD;
repeating said spin coating process until predetermined target perm value is reached; and
analyzing the prepared films to determine the thickness per deposition cycle and resulting film roughness.

19. The method of claim 18 which further includes the step of selecting target permeability values in the range of 3-60 m³/day flow rate, 0 to 99.9% salt rejection, and 0 to 99.9% boron rejection.
